(19) United States
(12) Patent Application Publication
(10) Pub. No.: US 2003/0179376 A1
(43) Pub. Date: Sep. 25, 2003

(54) Artificial star generation apparatus and method for reflective, refractive, and catadioptric telescope systems

(75) Inventors: William R. Houde-Walter, Rush, NY (US); Andrew J. Murnan, Webster, NY (US)

Correspondence Address: Stephen B. Salai, Esq., Harter, Secrest & Emery LLP, 1600 Bausch & Lomb Place, Rochester, NY, 14604-2711, US

(73) Assignee: LaserMax, Inc., Rochester, NY

(21) Appl. No.: 10/391,968

(22) Filed: Mar. 19, 2003

Related U.S. Application Data
(60) Provisional application No. 60/365,632, filed on Mar. 19, 2002.

(51) Int. Cl. G02B 5/32

(52) U.S. Cl. 356/399; 359/15

(57) ABSTRACT

This invention describes an apparatus and method for generating artificial stars for the simple collimation of catoptric, dioptric, and catadioptric telescopes using a light source along with an appropriate hologram and housing to generate collimated laser beams that enter the front aperture of the telescope. The apparatus of this invention can be fastened to the outside of the telescope aperture. In addition, this invention allows the apparatus position to be adjusted at its tip and tilt axis to center an artificial star under the view of the ocular. The light source illuminates the hologram from some off axis position. Once the hologram is illuminated, the collimated beam emanates from the hologram with a slightly different angle. When these beams are then viewed with the telescope they appear as artificial stars.

### CROSS REFERENCE TO RELATED APPLICATIONS

This application claims priority to provisional application Serial No. 60/365,632 entitled ARTIFICIAL STAR GENERATION FOR COLLIMATION OF REFLECTIVE, REFRACTIVE AND CATADIOPTRIC TELESCOPE SYSTEMS, filed Mar. 19, 2002.

### STATEMENT REGARDING FEDERALLY SPONSORED RESEARCH OR DEVELOPMENT

Not Applicable

### REFERENCE TO A “SEQUENCE LISTING

Not Applicable

### BACKGROUND OF THE INVENTION

1. Field of the Invention

This invention addresses an apparatus and method for the collimation of telescopic optical systems and testing of their optical characteristics and more particularly to the illumination of an off axis hologram selected to generate one or more collimated non-parallel beams to the optical system of the telescope and the alignment of the optical system in response to the collimated beams.

2. Description of Related Art

Several methods exist for collimation of telescopes. A telescope factory during manufacturing may use an auto collimator that produces a collimated light beam. Such tools are large, heavy and expensive so telescope owners use other methods involving the use of a real star or an artificial star. For Newtonian style telescopes a combination sight tube and Cheshire eyepiece collimator or a LaserMax TLC laser collimator is commonly used. For catadioptric and dioptric telescopes a point source is required for precision alignment. A real star is commonly used for collimation, but it is not ideal due to atmospheric turbulence that causes the star image to vary in intensity, position and also causes aberration. This effects resolution by limiting the accuracy of alignment and reducing the contrast of the telescope. An additional drawback to using an actual star is that during collimation the star frequently disappears from the field of view due to the high magnification, leading to the need for repetitive exchanges between shorter and longer focal length oculars in order to assist in re-entering of the star into the field of view. Further, the telescope mount requires accurate tracking of the star, which only adds to the difficulty of collimation using actual stars.

Prior methods have some impracticalities associated with them. When transporting a telescope from home to the observation site the optical elements can change in alignment by some small amount, which is enough to cause some degradation of an image. This necessitates site-based collimation for precision alignment. Prior methods are time consuming and the collimating equipment is difficult to set up.

There is a need for a method and apparatus for collimating telescopes that is accurate, simple and practical, even for the casual telescope user.

### BRIEF SUMMARY OF THE INVENTION

This invention describes an apparatus and method for generating artificial stars for the alignment of catoptric, dioptric, and catadioptric telescopes. This invention uses a laser or a broad band light source along with an appropriate filter, hologram, and housing to generate collimated light beams that enter the front aperture of the telescope. The apparatus of this invention can be fastened to the outside of the telescope aperture and has a large center opening, or slots, to provide access to the adjustment screws of either the secondary optical element or objective, of the telescope. In addition, this invention allows the apparatus position to be adjusted at its tip and tilt axis to center an artificial star in the view of the ocular. The light source illuminates the hologram from some off axis position. Once the hologram is illuminated, the collimated beams emanate from the hologram with a slightly different angle. When these collimated beams are then viewed with the telescope they appear as artificial stars.

The generation of an artificial star from a hologram directly over the aperture of the telescope has the advantage that it eliminates the effect of atmospheric turbulence allowing the observer to have high precision collimation for focusing the telescope. In addition, the use of several collimated beams emanating from the hologram provides for a plethora of stars. This allows the observer to not have to switch to a longer focal length ocular to re-center a star.

Further, this method of telescope focusing is not limited by the time of day, or telescope location since the invention fits directly over the aperture of the telescope. This allows for a practical, simple, compact, and highly accurate method of collimation for catoptric, dioptric, and catadioptric telescopes.

This invention can also use holograms with images that include additional stored information in disparate configurations. This invention may also be used to perform other functions besides alignment. These other functions include the examination and testing of various optical characteristics of the telescope such as telescope resolution and aberration.

### BRIEF DESCRIPTION OF THE SEVERAL VIEWS OF DRAWINGS

FIG. 1 is a perspective side view of the invention for a catadioptric and catoptric telescope.

FIG. 2 is a perspective side view of the invention for a dioptric telescope.

FIG. 3 is a cutaway view of a portion of FIG. 1 taken at 3-3.

FIG. 4 is a cutaway view of a portion of FIG. 2 taken at 4-4.

FIG. 5 is a top view of the adjustment device of FIG. 2 taken at 5-5.

FIG. 6 is a top view of FIG. 1.

FIG. 7 is a cutaway view of a portion of FIG. 1 taken at 7-7.

FIG. 8 is a cutaway view of a portion of FIG. 2 taken at 8-8.

FIG. 9 is a schematic of the invention showing an alternate arrangement.

FIG. 10 is a schematic showing the adjustment device of FIG. 9.

FIGS. 11a-d are drawings of potential projected fields of view with the invention mounted on a telescope.

FIG. 12 is a perspective view of the invention mounted on a dioptric telescope.

FIG. 13 is a diagrammatic representation of a hologram generating device.

FIG. 14 is a diagrammatic representation of a hologram generating device.

FIG. 15 is a schematic showing the light source as fiber optic emitters.

### DETAILED DESCRIPTION OF THE INVENTION

This invention in conjunction with a catadioptric, dioptric, or catoptric telescope can create several diffracted collimated light beams directed through the front aperture of a telescope to provide the illusion of several point sources when viewed with an ocular. These point sources appear as artificial stars, which allow an observer to quickly and conveniently collimate a telescope without the need to focus on real stars in the sky that are only visible at night and which produce images that are distorted by atmospheric turbulence.

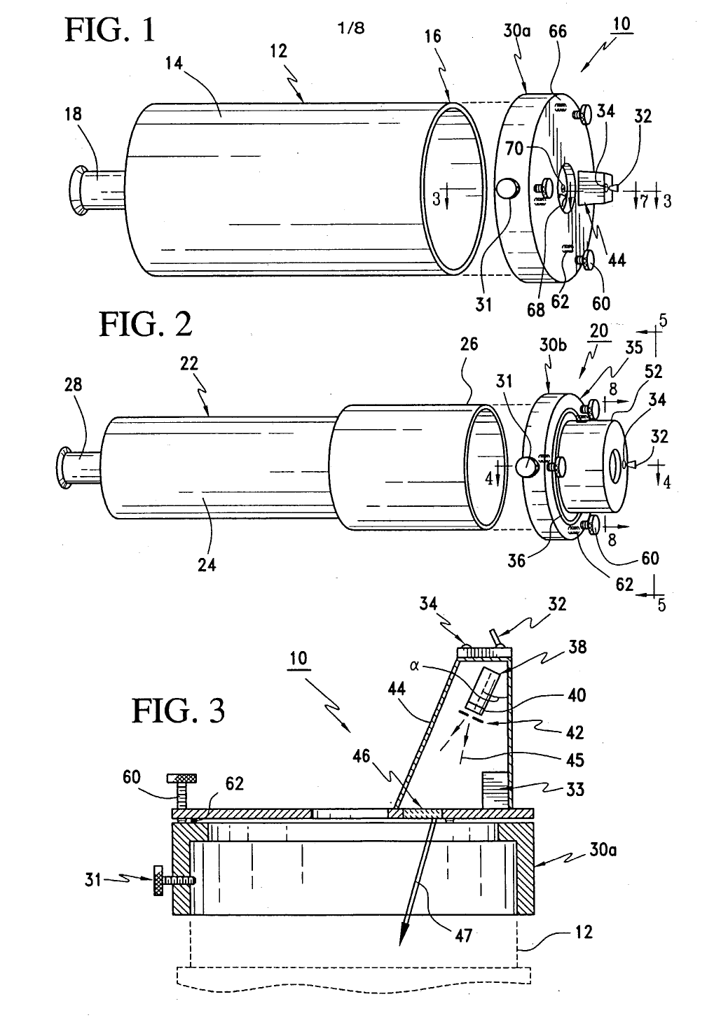

A diagrammatic view of the optical alignment configuration for an artificial star generator (ASG) 10 for catadioptric and catoptric telescopes is shown in FIG. 1. A catadioptric or catoptric telescope 12 has a body 14 with a front 16 and an ocular 18. FIG. 2 shows a diagrammatic view of an alternate optical alignment configuration for another artificial star generator (ASG) 20 for a dioptric telescope 22. Just like the catadioptric and catoptric telescopes, the dioptric telescope 22 has a body 24 with a front 26 and an ocular 28.

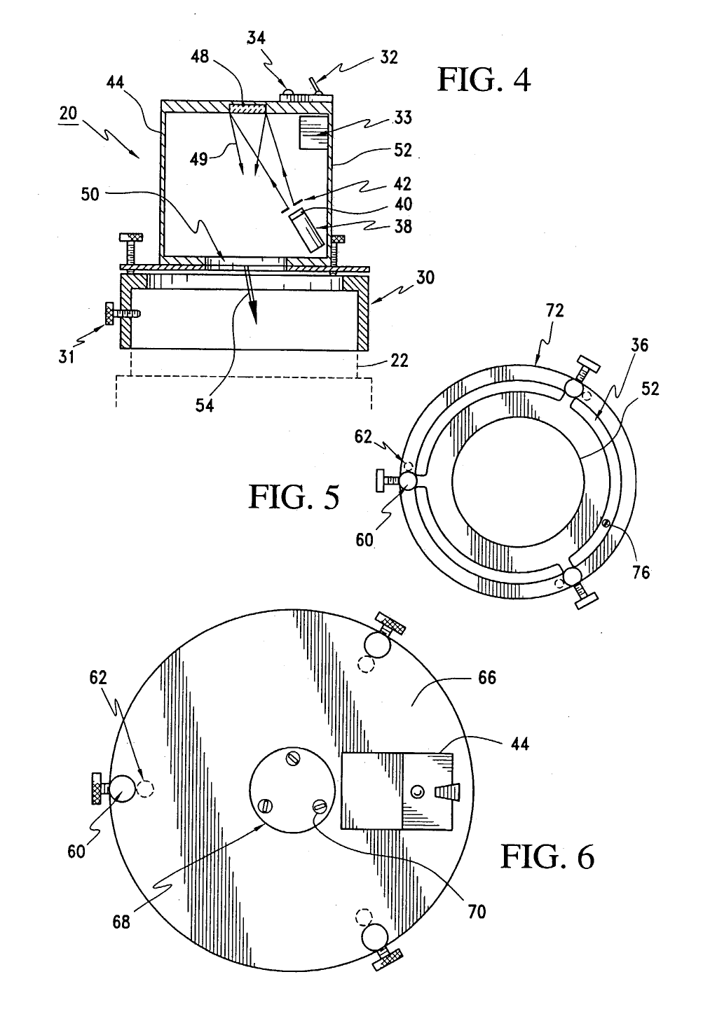

The ASG 10, 20, for both types of telescopes, fits over the front of the respective telescope. Each ASG 10, 20 has a base 30a, 30b, and three locking screws 31 that hold the base in place as shown in FIG. 3 and FIG. 4. The ASG is activated by a switch 32. Batteries 33 provide power to an LED safety emission light 34, which is illuminated while the ASG is operating. FIG. 2 shows plate 35 with slots 36 to provide access to the adjustment screws of the dioptric telescope.

The batteries 33 also provide power to a light source 38 such as a laser diode module. In certain circumstances, a broad band light source, such as an illuminating beam generator with an appropriate filter 40, to make the beam more coherent, can be used, as will be discussed below in more detail. The light source 38 emits light that passes through a pinhole 42. The pinhole 42 helps to reduce scatter off an optical mount 44.

There are two types of coherence. The first type is temporal coherence. Monochromatic light (one pure color) is an example of light that exhibits temporal coherence. The second type is spatial coherence. Light emitted from a point source, such as a star is an example of light that has spatial coherence. In contrast to stars, a planet or moon is not a point source, it is a broad spatial source. The lack of either form of coherence in the recording or reconstruction of a hologram that has any significant depth of field (such as an image with a depth of field greater than a few millimeters) causes the hologram to be blurred. This includes the light sources used to make holograms such as the Russian reflective hologram and the Polaroid white light transmission hologram which has a wave light filter built in. Neither of these forms of holograms work well for the current invention. Not all lasers are spatially or temporally coherent.

In the ASG 10 for catadioptric or catoptric telescopes, as shown in FIG. 3, a divergent coherent polarized output beam 45 enters a hologram 46, preferably produced by spatially and temporally coherent light, which diffracts the output beam 45 into at least one collimated beam 47. Note that there can be several collimated beams 47 that emanate from the hologram 46, allowing an infinite variety of images to be formed such as the stars making up the various constellations. The hologram 46 of this invention, which appears to produce an image at infinity, needs a light source that exhibits coherence such as a largely monochromatic light source. Some holograms, where the image is closer to the image plane, can use white light or quasi-monochromatic light to record them and also to view them. The imaging or reconstruction beam 45 needs to illuminate the hologram at an angle that approximates the angle, often referred to as the divergence angle, used to record the hologram. The laser required for recording a hologram that produces images at infinity should be coherent, both temporally and spatially, for the best results. In the play back mode it is not so critical but the light source needs to duplicate the divergence angle of the reference beam used to record the original hologram or distortion of the image will result.

As discussed above, the Russian reflection hologram and the Polaroid white light transmission hologram, do not have the capability of a producing the best hologram to be used in the ASG 10, 20. If other light sources, such as LEDs and mercury arc lamps are used they should be filtered using interference filters or passed through diffraction gratings to improve performance. These filtering techniques cause the light source to lose most of its intensity and reduces efficiency, but can improve the characteristics of the light. As discussed above, a light source that exhibits spatially coherent characteristics is preferred when recording a hologram 46 for the ASG 10, 20. Methods of recording the hologram 46 will be discussed in more detail below. After the light passes through the hologram 46, recorded in a manner discussed below, the exiting collimated, diffracted beams appear as artificial stars or other virtual images to an observer at the ocular 18, 28 as shown in FIGS. 1 and 2. It is clear that the location of the ASG could be varied as needed to perform the test in various different locations on the apparatus and in relation to the lens.

As shown in FIG. 3, the light source can be moveable by an angle α that represents the angular displacement of the light source 38 and/or optics coupled to the light source 38 from its original position. This angular displacement of the light source causes a resultant angular displacement of the reference beam 45. This angular displacement of the reference beam in the ASG can be used to simulate tracking of the stars in the sky, allowing the telescope to be focused even if the virtual stars created by the hologram start to move out of the view of the ocular, because the tracking will essentially move the virtual stars back into view. This process simulates the tracking of the night sky, this process when used in conjunction with the correct holograms with a wide field of view which will be described in more detail later. This tracking can be automated using a simple motor to move the light source through incremental changes in the angle α that may be preprogrammed to duplicate celestial motion. For instance, this will allow one to test other aspects of a telescope, such as the tracking mechanism of a telescope used in astro-photography.

FIG. 4 shows ASG 20 attached to on the dioptric type telescope 22. The illumination source such as that discussed above in conjunction with FIGS. 1 and 3, is used in ASG 20 to produce coherent light beams that are directed to a reflective hologram 48, similar to hologram 46 that has an additional reflective surface. The reflective hologram 48 focuses a reflected collimated beam(s) 49 toward an opening 50 in an optical mount 52 as shown in FIG. 4. The reflective hologram 48 can act as an interference filter and can reflect specific wavelengths of light. When the reflective hologram 48 acts as a filter, that filter can allow a less coherent light source to be used in the present invention. The reflective hologram 48 also allows other wave dependent manipulations of the holographic image to be performed. FIG. 4 shows one or more collimated beams 54 directed towards the ocular as also shown as beam 56 in FIG. 3. An adjustment device, such as three leveling screws 60 and tension springs 62, shown in FIG. 5, allow the observer to center the nearest artificial star under view of the ocular 28 in ASG 20.

The ASG 10 for catadioptric and catoptric telescopes has a plate 66, as shown in FIG. 6. Plate 66 has a large center opening 68 to provide access to adjustment screws 70 of either the secondary optical element or objective, of the catadioptric and catoptric telescopes 12. The ASG 20 for dioptric telescopes 22 has a different plate 72, as shown in FIG. 5. The plate 72 has slots 36 to provide access to the adjustment screws 76 of the dioptric telescope 22 which has a different configuration from the catadioptric and catoptric telescopes 12.

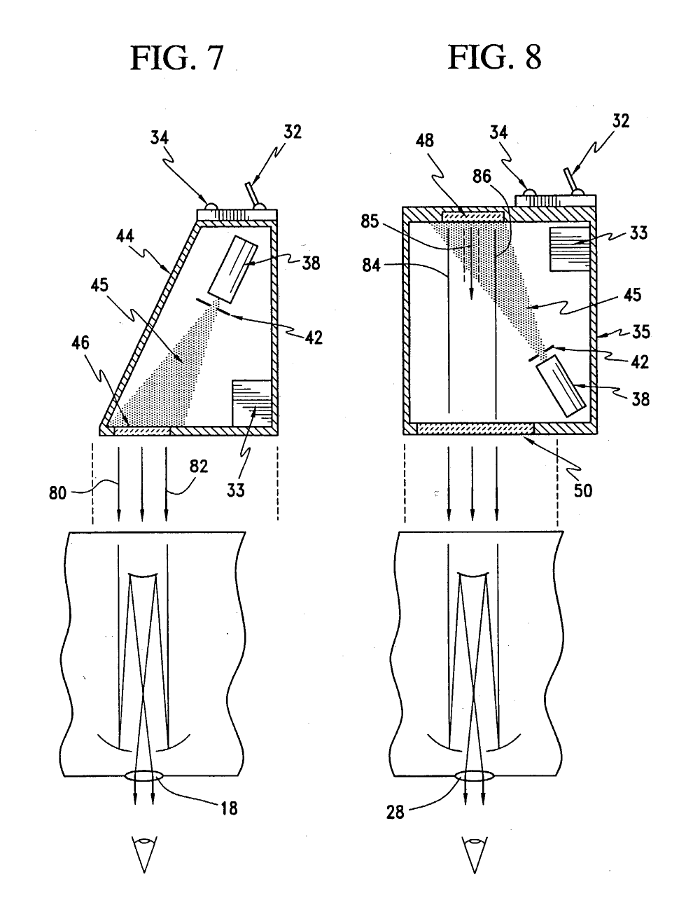

FIG. 7 shows the light path of two collimated beams 80, 82 directed toward the lens 18 of the ASG 10 for a catadioptric/catoptric telescope 12. FIG. 8 shows the light path of two collimated beams 84, 86 directed toward the lens 28 of the ASG 20 for a dioptric type telescope 22. In both of these cases, the collimated beams are actually focused at a point near the lens in order to allow focusing of the telescope.

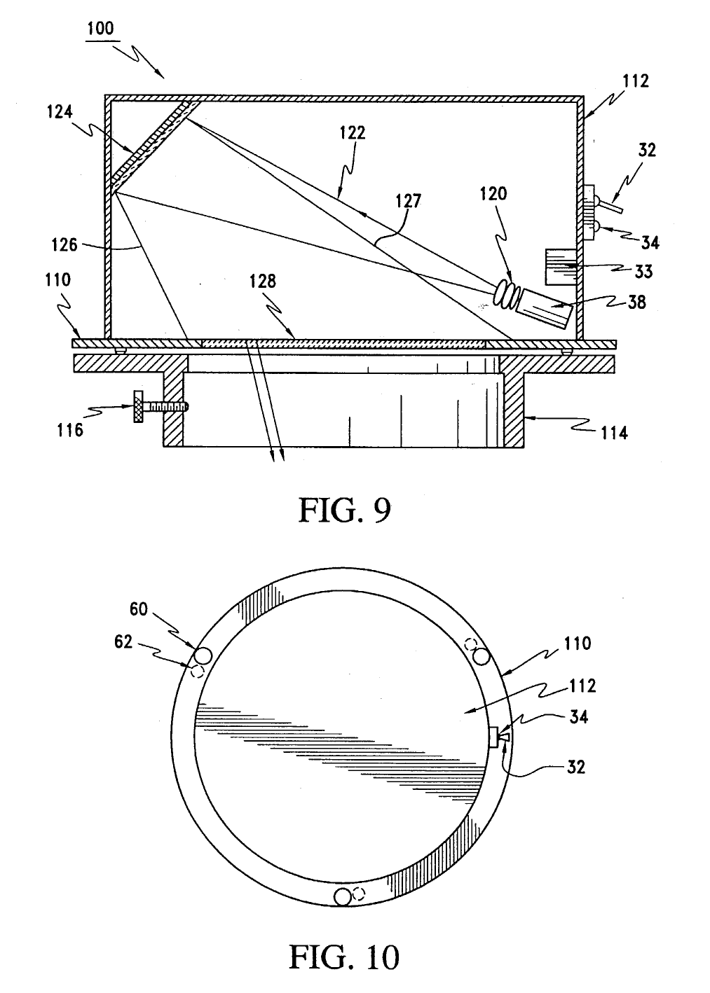

In the alternate configuration as shown in FIGS. 9 and 10, an artificial star generator (ASG) 100 has a large plate 110 adjacent a housing 112. ASG 100 is attached to a base 114 that includes locking screws 116 to attach the ASG 100 to the front of a telescope. As discussed above, the light source 38 that is used in ASG 100 can be a laser diode module, or a broad band light source with an appropriate filter. One type of filter that can be effective in enhancing the essential characteristics of the broad band light source, is an interference filter. One type of interference filter is a narrow band filter, like those used in the thin film technology. An interference filter can eliminate the wavelengths that are not desired, making the light source more coherent and thus, more effective in producing the type of hologram necessary for producing collimated light, as described in this invention.

FIG. 9 shows the ASG 100 with the light source 38 and a series of optics or optical devises 120. These optics can be used to create circularized polarized light and/or to diverge the light emitted from the light source 38 and can include such optical devices as a lens, an optical surface, a reflective surface such as a mirror, a filter and defraction gratings. The light exiting the optical device(s) 120 is represented by beam 122. Beam 122 is directed toward mirror 124 and continues to diverge as it is reflected off the mirror 124, as represented by bounding ray paths 126, 127. The mirror 124 should be flat to a fraction of a wavelength. The mirror 124 can be created by coating an optical surface with a multi-layered di-elective coating that enhances efficiency. Such a coating would make the surface very efficient, up to 99%, in its reflective ability. It is also possible to coat the reflective surface such that it will reflect one or more specified wavelengths of light. These coatings are useful when a light source needs to be spatially coherent, as in this invention.

The ASG 100 also includes a hologram 128 similar to hologram 46 described above. This embodiment produces a beam of light that intersects the plane of hologram 128 with light of a more uniform intensity. This is because all light beams are gausian, thus, when the center of the gausian beam is expanded and the edges eliminated, then the more uniform gausian part of the beam is all that intersects the hologram. It is possible to combine the reflective hologram 48 discussed above with mirror 124 allows one or two holograms to be used in conjunction in ASG 100.

The hologram 46 of this invention is recorded from an object beam whose image includes a point source, or many point sources in a pattern. These holograms, which can be referred to as collimar holograms, are specifically created as described below. Dennis Gabor, Nobel Prize Winner for the invention of Holography, is credited with the creation of one of the first holograms, a hologram of a model of a small village. The original concept was to use a lens to project the image at a great distance away such that the viewer could use binoculars to observe the virtual village as though it were real. In 1976, the Applicant, working with Dr. Steve Benton at Polaroid Labs, produced a holographic art piece that depicted a crystal lattice of a salt crystal known as Crystal Beginnings. This holographic image looked like a point source, but did not produce a collimated wavefront, as required in the present invention.

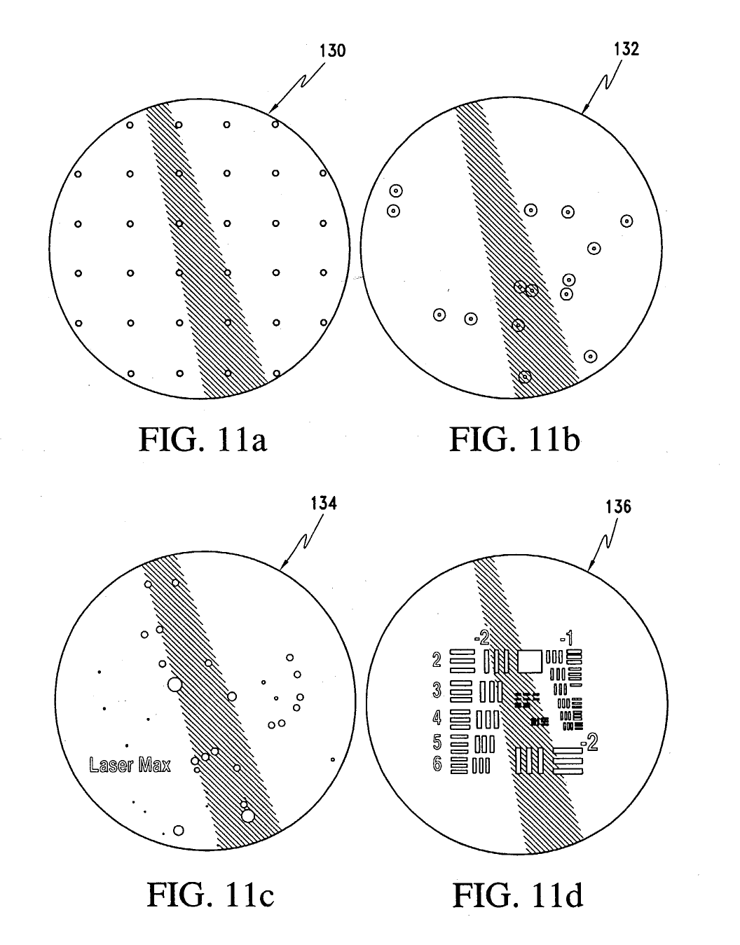

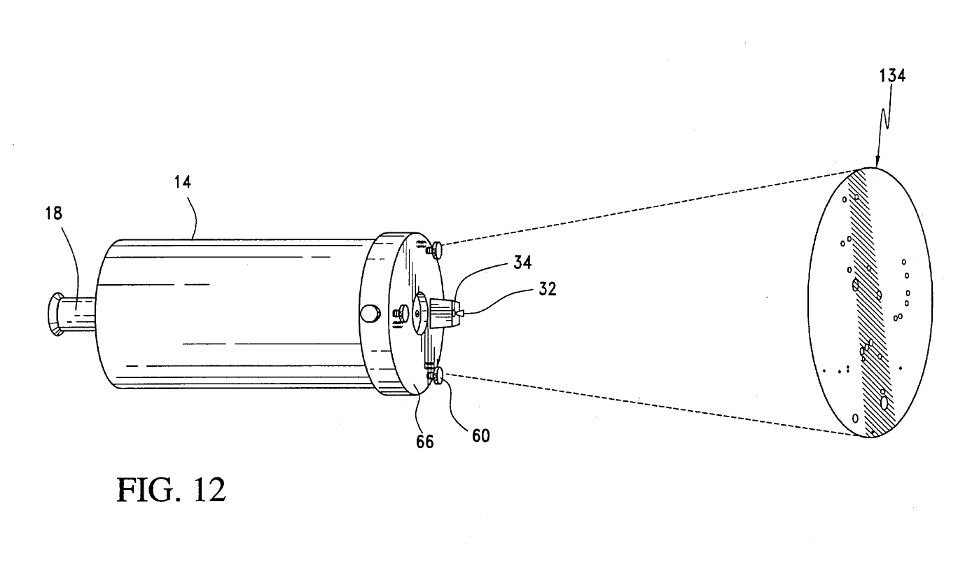

The ASG 10, 20, 100 requires a new kind of hologram which will be referred to as a collimated hologram or a point source hologram. This collimated hologram is produced form a collimated wavefront. The resulting collimated beams from the collimated wavefront in the above-described ASG 10, 20, 100 appear as artificial stars that are actually virtual images. This collimated hologram 46 permits a method for conducting a star test over the full aperture of the telescope which can be used to determine aberrations in the telescope, or as described above, to collimate the telescope. An example of the type of image that the collimated hologram 46 can produce is shown in FIG. 11a, the field of view may contain a square pattern series of artificial stars 130 that allow one star to always be in the field of view. This square pattern series of stars 130 can be used in conjunction with the tracking mechanism discussed above. When a star is viewed under high magnification the star may look like a bulls-eye which is caused by the effects of diffraction on the pattern 132, as shown in FIG. 11b. This can occur when the telescope is collimated and/or slightly out of focus. A similar pattern will emerge when the stars are under low magnification, although the stars may look more like a donut. FIG. 11c is a star pattern 134 shown as the Orion constellation, but could be any star pattern and can include a LaserMax trademark, or other trademark, in the field of view of the ocular. FIG. 11d shows a test mark 136 that can be used for collimating the telescope. The projection of a star pattern with an assembly drawn of the current invention on a telescope is shown in FIGS. 12.

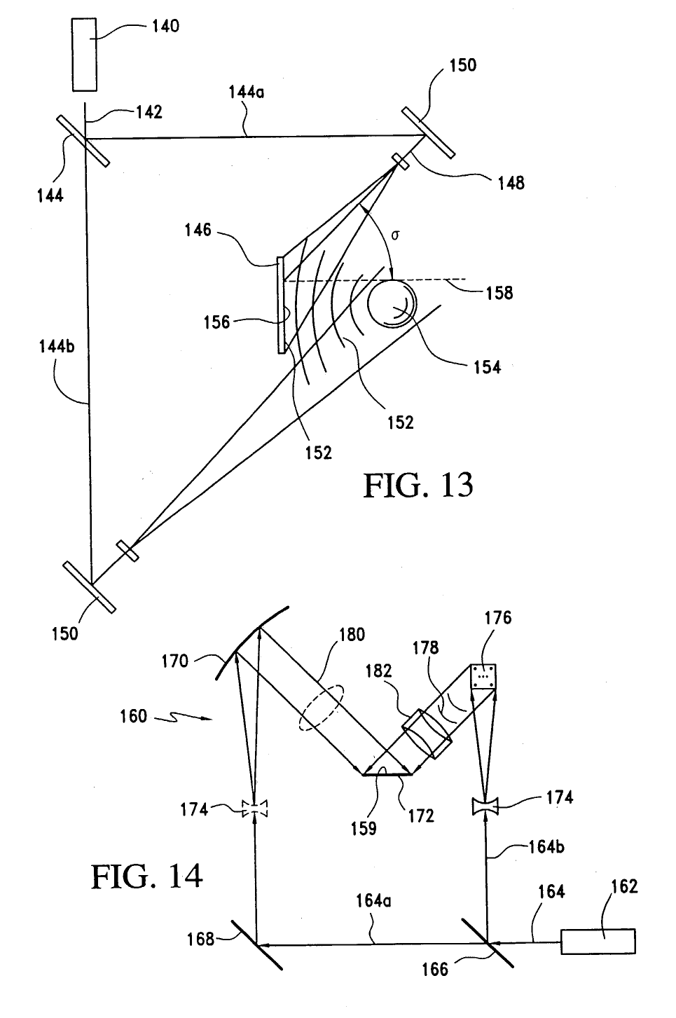

FIG. 13 shows a diagrammatic representation of the components necessary for manufacturing a hologram. In order to generate a hologram, a coherent light source 140 produces one or more beams of light 142 that are directed to a beam splitter 144 which can consist of a prism or a silver prism or other means of splitting the light beam into two parts, 144a and 144b. Beam 144a is directed toward the hologram taking plate 146, is often referred to as the reference beam 148. Both beams 144a and 144b can be reflected off of an optical device 150 such as a mirror or other devices that can change the direction and other characteristics of the light beam. The other portion of beam 142b is often referred to as an object beam 152, is directed toward the object 154 to illuminate the object. The object beam 152 is also directed toward the hologram taking plate 146.

A hologram is essentially a recording of the optical setup, it reproduces the phase, angle and divergence of the original setup as long as the reference is an exact duplicate of the original reference beam used to record the hologram. Note that each separate point source will effectively have its own angle. Hologram 46 is a type of hologram often referred to as an off-axis hologram which is a refinement of the on-axis hologram. In an on-axis hologram, the image is obscured by the reference beam which will glare in the viewers eyes. The ASG 10, 20 of the current invention works well when the reference beam illuminates the hologram with a 45 degree offset, ±20 degrees. This is a 45 degree off set angle measured between the referenced light beam 148 and a plane perpendicular to the surface 156 of the hologram shown as axis 158. This angle clearly designated as angle σ in FIG. 13. The more acute the angle σ, the more of the reference beam is visible to the viewer. The more obtruse the angle, as it approaches the plane of the hologram, the higher the frequency of the grating formed and the more difficult it is to record the hologram 46 using common holographic recording materials. When decreasing the angle, the spatial coherence and efficiency is decreased, which is not as desirable for the current invention. When increasing the same, the efficiency increases, but the hologram is more difficult to record, as discussed above.

FIG. 14 is one arrangement for making a collimating hologram 159. Hologram apparatus 160 consists of a laser 162 capable of producing coherent light of the type described above. One of the coherent light beams 164 is shown illuminating a beam splitter 166 which splits the beam 164 into two components, a reference component 164a and an object component 164b. The reference component 164a can be directed to various devices such as a directional mirror 168 and a parabolic mirror 170 that reflects the beam 164a toward a hologram taking plate 172.

The object illumination beam component 164b can be directed through a diverging lens 174 which may be replicated in the reference beam component path if needed. The object illumination beam component 164b then is directed toward and illuminates an object 176. This object can be a transparency or a front-lit photograph of the star pattern. The light reflected from object 176 is directed towards the hologram taking plate 172. The wavefront in hologram producing apparatus 160 emanating from the object 176, is identified as 178 and is commonly referred to as the object beam. Both the object beam 178 and a reference beam 180 are directed toward the hologram taking plate 172. The object beam is refracted through a collimating lens 182, which images the star pattern at infinity. Note that the reference beam 180 does not require any optics be placed in its path for this invention, but could have additional optics to converge, diverge, or collimate the reference beam as required for convenient and effective play back of the recorded image. The object beam in this case is a series of collimated wavefronts as described above. Hologram apparatus 160 produces an image that when viewed in playback appears to be at infinity and if the object is a star or represents a group of stars (a constellation), the constellation will appear as if at infinity.

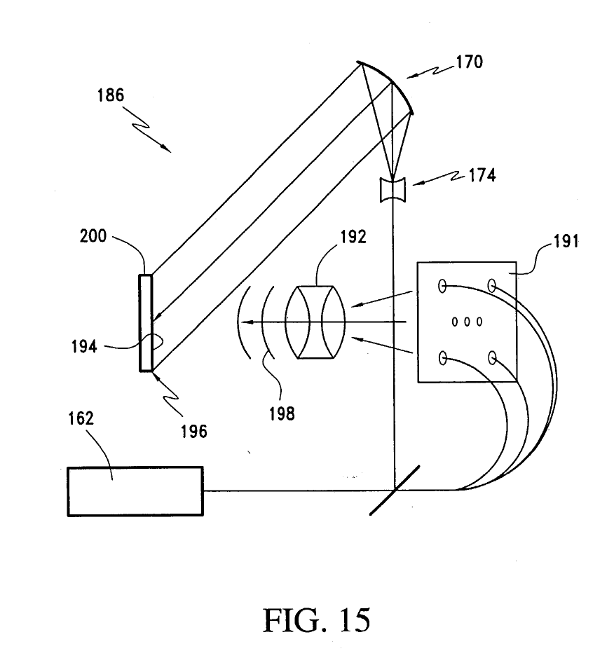

Another arrangement for making a collimating hologram 159 is using fiber optics as a light source. FIG. 15 shows a portion of a collimating hologram apparatus 186. An object beam 188 in this apparatus can be produced from a real object or from one or more fiber emitters 190 shown held together and/or emitting from a fiber optic mounting plate 191 to form the pattern simulating any real object, such as a constellation of stars. A collimating imaging lens 192 focuses the object beam on the plate. The collimating imaging lens could be a single lens, multiple lens, or holographic optic lens. An important feature of all of these lenses is that they allow the object(s) to be focused at infinity when recording the hologram. The collimating imaging single lens 192 has a focal length equal to the distance from the lens 192 to the emitter(s) 190. A composite lens, also known as a complex or multi-element lens, would have a wider field of view then most single lenses and would work well for this invention. An additional lens feature that works well with this embodiment is the capability to image a flat field. The use of specific multi-element lens to correct for curvature so that the recorded image is a flat field is one way to add this desirable feature.

The collimating imaging lens 192 focuses on a plate, thus forming a collimating holographic image 194 which appears to be at infinity. The laser 162 used to generate a collimating hologram 196 should produce coherent light that is monochromatic. The preferred lenses 182 and 192, FIG. 14, should each be a wide field collimation lens. This could be a convex lens if the beam is diverging or a concave lens of the beam is converging. Lens 182, 192 are situated such that the illuminated objects 176 and 190 are at the focal point of each lens. It is also possible to use a parabolic mirror or one or more of a number of holographic optical elements to help focus one or more objects onto the hologram taking plate 200 which is also known as the H1 master. A mirror or series of mirrors would allow one object or group of objects to be replicated a number of times without actually having to have more than one object to produce a hologram with identical objects.

After one holographic plate is made by refracting the light from a plurality of separate point sources through the collimating lens 182, 192, then the hologram can be replicated. The collimating hologram 159, 196 can be replicated in a number of means such as through contact printing with the original holographic plate or H1 plate, by playing back the reference beam or it can be replicated through other means known in the industry.

For resolution testing, a hologram of an USAF 1951 Test Target may be employed. The observer needs only to center a star using adjustment devices such as the three leveling screws 60 and one or more tension springs 62, as shown in FIGS. 5 and 6, as well as FIG. 10, to collimate as usual when using any test or star pattern.

The resolution target test is performed before and after collimation. The difference in resolution is the amount of improvement in the alignment of the telescope measured as an alignment improvement factor. This provides a method of quantifying the alignment of the telescope and noting what the maximum resolution of the telescope is for that particular set of parameters.

While the invention has been described in connection with a presently preferred embodiment thereof, those skilled in the art will recognize that many modifications and changes can be made therein without departing from the true spirit and cope of the invention, which accordingly is intended to be defined solely by the appended claims.

In the claims:

1. An apparatus for aligning an optical element in a telescope, comprising:
(a) a light source to generate a coherent beam; and
(b) a collimating hologram to create at least one collimated beam.

2. The apparatus of claim 1, further comprising an adapter to operably retain the collimating hologram with respect to the telescope.

3. The apparatus of claim 1, wherein the telescope is one of a catoptric, dioptric and catadioptric type.

4. The apparatus of claim 1, wherein the light source is a laser.

5. The apparatus of claim 1, wherein the light source is a broadband light source.

6. The apparatus of claim 1, further comprising a plate having an aperture positioned to allow access to telescope adjustment devices.

7. The apparatus of claim 1, further comprising a reflective surface optically intermediate the light source and collimating hologram.

8. The apparatus of claim 7, wherein the reflective surface is adjacent the collimating hologram.

9. The apparatus of claim 7, further comprising an optical device intermediate the light source and the reflective surface.

10. The apparatus of claim 7, further comprising a polarizing filter intermediate the light source and the reflective surface.

11. The apparatus of claim 1, further comprising an adjustment device.

12. A method of aligning an optical element in a telescope, comprising:
(a) illuminating a hologram with a light source from an off axis position to create at least one collimated beam;
(b) aligning the optical element in response to at least one of the hologram generated collimated beams.

13. The method of claim 12, further comprising a light source tracking device to angularly displace the light source before it illuminates the hologram.

14. The method of claim 12 by further comprising reflecting the light off a reflective surface optically intermediate the light source and the hologram.

15. The method of claim 12 further comprising directing the light through an optical device optically intermediate the light source and the hologram.

16. The method of claim 12, further comprising illuminating the hologram with a broad spectrum beam.

17. The method of claim 12, further comprising locating the hologram at a front aperture of the telescope.

18. The method of claim 12, further comprising orienting the collimated beams in a regular pattern.

19. The method of claim 12 further comprising focusing the collimated beams at a telescope ocular.

20. The method of claim 12, further comprising filtering the light source.

21. The method of claim 12, further comprising resolution testing the alignment of the optical element in response to at least one of the collimated beams and an adjustment device.

22. The method of claim 21, further comprising aligning the optical element before and after collimation to determine an alignment improvement factor.

23. A method for making a collimated hologram on a hologram plate for aligning an optical element in a telescope, comprising:
a) passing an object beam from a plurality of point sources through a collimation lens towards the hologram plate;
b) directing the reference beam towards the same hologram plate; and
(c) generating a collimating hologram from a combination of the reference beam and the object beams.

24. The method of making of claim 23, further comprising passing the reference beam through a lens.
